(19) United States
(12) Patent Application Publication
(10) Pub. No.: US 2026/0038859 A1
(43) Pub. Date: Feb. 5, 2026

(54) POROUS BODY HAVING UNIFORM PORES, METHOD FOR MANUFACTURING SAME, AND METHOD FOR MANUFACTURING ELECTROLYTE MEMBRANE

(71) Applicants: Hyundai Motor Company, Seoul (KR); Kia Corporation, Seoul (KR)

(72) Inventor: Hee Jin Woo, Hwaseong (KR)

(21) Appl. No.: 18/954,034

(22) Filed: Nov. 20, 2024

(30) Foreign Application Priority Data
Aug. 2, 2024 (KR) 10-2024-0103141

(51) Int. Cl. H01M 8/1069; H01M 8/1004; H01M 8/1039

(52) U.S. Cl. CPC H01M 8/1069; H01M 8/1039; H01M 8/1004

(57) ABSTRACT

A method for manufacturing a porous body with uniform pores includes steps of: (a) injecting a fluorine-based polymer molded body into the form of a fiber and modifying the surface thereof; (b) applying an adhesive to the surface of the fiber; (c) forming a fiber net with uniform pores through the fiber; (d) repeatedly performing the formation of the fiber net in the step (c) while contacting the fiber remaining after performing the step (c) or a separate fiber on which the steps (a) and (b) have been performed with the fiber net, thereby manufacturing a preliminary porous body in which a plurality of fiber nets are laminated; and (e) stretching and curing the preliminary porous body. The method for manufacturing an electrolyte membrane further includes impregnating the porous body with an ionomer, rolling the resultant product, and forming an ionomer layer on both surfaces.

### CROSS-REFERENCE TO RELATED APPLICATION

This application claims under 35 U.S.C. § 119 (a) the benefit of Korean Patent Application No. 10-2024-0103141 filed on Aug. 2, 2024, the entire contents of which are incorporated herein by reference.

### BACKGROUND

### Technical Field

The present disclosure relates to a porous body having uniform pores, a method for manufacturing the same, and a method for manufacturing an electrolyte membrane.

### Background

Porous bodies, membranes containing fluorine-based polymers, are applied in various fields such as fuel cells and water electrolysis systems. The e-PTFE (expanded PTFE) membrane can be made into a thin film and has excellent mechanical strength, so it is mainly applied as an electrolyte membrane in the membrane-electrode assembly of a fuel cell, but the volume of the e-PTFE electrolyte membrane may repeatedly expand and contract due to moisture generated during fuel cell operation. In addition, if the density of the e-PTFE electrolyte membrane is non-uniform, the mechanical stability against such dimensional changes such as expansion may be lowered, and if the pores are non-uniform, the conductivity of hydrogen ions may deteriorate.

### SUMMARY OF THE DISCLOSURE

The present disclosure is intended to solve the problems as described above, and an object of the present disclosure is to provide a method for manufacturing a porous body having a uniform pore structure, a porous body, and an electrolyte membrane.

In addition, an object of the present disclosure is to provide a method for manufacturing a porous body having stable physical robustness and a minimized deviation in volume expansion rate depending on location by having a uniform density, a porous body, and an electrolyte membrane.

In addition, an object of the present disclosure is to provide a simplified and excellently productive manufacturing method for manufacturing a porous body having uniform pores and physical properties, and an electrolyte membrane.

The object of the present disclosure is not limited to the objects mentioned above. The object of the present disclosure will become more apparent from the following description and will be realized by the means and combinations thereof described in the patent claims.

A method for manufacturing a porous body with uniform pores according to the present disclosure may include steps of:
(a) injecting a fluorine-based polymer molded body into the form of a fiber and modifying the surface thereof;
(b) applying an adhesive to the surface of the fiber on which the step (a) has been performed;
(c) forming a fiber net with uniform pores through the fiber on which the step (b) has been performed;
(d) repeatedly performing the formation of the fiber net in the step (c) while contacting the fiber remaining after performing the step (c) or a separate fiber on which the steps (a) and (b) have been performed with the fiber net, thereby manufacturing a preliminary porous body in which a plurality of fiber nets is laminated; and
(e) stretching and curing-treating the preliminary porous body.

The method may further comprise controlling the thickness of the fiber during injection to be about 1 μm to 10 μm. The modifying agent used in the modification process may comprise an alkali metal complex solution. The adhesive applied to the fiber surface may be selected from epoxy-based resin, acrylic resin, urethane-based resin, or a combination thereof. The adhesive may be applied such that the weight ratio of the fiber to the adhesive is about 1:0.1 to 1:1. The formation of the fiber net may involve forming a first fiber structure with a plurality of straight lines, and forming a second fiber structure in contact with the first, arranged at a predetermined angle.

The first fiber structure may include straight lines of fibers arranged at a predetermined interval in the x direction, and the second fiber structure may include straight lines arranged at an interval in the y direction, with the x and y directions being orthogonal to each other.

The first fiber structure may be formed using a first arrangement mechanism, which includes a first set of pins arranged at a specific interval in the x direction and a second set of pins facing in the opposite direction, with the second set of pins aligned to face the intervals between the first set of pins in the y direction.

The second fiber structure may be formed using a second arrangement mechanism, which includes a second set of pins arranged at a specific interval in the y direction, and a third set of pins arranged to face the intervals of the second set of pins in the x direction.

The number of times the fiber net formation process is repeated may be between 10 and 100 times.

The stretching process may be performed by moving the first and second arrangement mechanisms.

The stretching process may be carried out at a stretching ratio of about 1:1.2 to 1:20.

The curing process may be performed by applying hot air at a temperature of about 50° C. to 100° C.

The adhesive may be applied to form a layer with a thickness of about 0.1 μm to 2 μm, using either spray coating or dip coating methods.

A method for manufacturing an electrolyte membrane including a porous body with uniform pores according to one embodiment of the present disclosure may include
the steps (a) to (e), and include steps of: (f) impregnating an ionomer into the porous body manufactured in the step (e); (g) rolling the resultant product on which the step (f) has been performed; and (h) forming an ionomer layer on one surface and the other surface of the resultant product, respectively, on which the step (g) has been performed.
the rolling of the step (g) is performed at a temperature of about 30° C. to 150° C.

The method may further include a step of (i) heat-treating the resultant product on which the step (h) has been performed, wherein the heat treatment temperature of the step (i) is about 80° C. to 200° C.

A porous body according to one embodiment of the present disclosure may include: a first fiber structure in which a plurality of fiber nets including a fluorine-based polymer are laminated, the fiber nets including a part in which a plurality of fibers are arranged parallel to each other; a second fiber structure which is in contact with the first fiber structure, has a predetermined angle between the first fiber structure and the second fiber structure, and includes a part in which a plurality of fibers are arranged parallel to each other; and an adhesive layer which is included in a portion or all of the surface of the first fiber structure and a portion or all of the surface of the second fiber structure, and may have a pore uniformity according to Equation 1 below of 0.8 to 1.2.

Pore uniformity=average pore size measured from an object obtained by cutting a predetermined region of the porous body/average pore size measured from an object obtained by cutting another predetermined region of the porous body [Equation 1]

The porous body may be formed by laminating one fiber net and an adjacent other fiber net at the same horizontal position when viewed in the thickness direction.

According to the present disclosure, a porous body having a uniform pore structure, and an electrolyte membrane can be implemented.

In addition, a porous body having a uniform density to have stable physical robustness and having a minimized deviation in volume expansion rate depending on the location, and an electrolyte membrane can be implemented.

In addition, it is possible to simplify a manufacturing method and exhibit excellent productivity in manufacturing a porous body having uniform pores and physical properties, and an electrolyte membrane.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 is a flow chart illustrating a method for manufacturing a porous body with uniform pores according to one embodiment of the present disclosure.

FIG. 2 is a schematic diagram simply illustrating an electrolyte membrane according to one embodiment of the present disclosure.

FIG. 3 is a schematic diagram illustrating a method for manufacturing a porous body with uniform pores according to one embodiment of the present disclosure, and a method for manufacturing an electrolyte membrane.

FIG. 4 has its upper part illustrating a process in which a fiber passes through the surfaces of pluralities of first pins and first′ pins, and FIG. 4 has its lower part illustrating a subsequent process in which the fiber passes through the surfaces of pluralities of second pins and second′ pins.

FIG. 5 is a schematic diagram simply illustrating aspects of a first fiber structure and a second fiber structure, a fiber net, and a porous body in which the fiber net is laminated.

FIG. 6 is a flow chart illustrating a method for manufacturing an electrolyte membrane including a porous body with uniform pores according to one embodiment of the present disclosure.

FIG. 7 illustrates a process in which the fiber passes through the surfaces of pluralities of first pins and first′ pins in different aspects.

### DETAILED DESCRIPTION

As discussed above, the present disclosure relates to a porous body having uniform pores, a method for manufacturing the same, and a method for manufacturing an electrolyte membrane. More specifically, in aspects, the disclosure provides a method for manufacturing a porous body by injecting a fluorine-based polymer into fibers, applying an adhesive to the fibers, forming a fiber net, laminating multiple fiber nets, and stretching and curing the porous body. The disclosure also covers a method for manufacturing an electrolyte membrane by impregnating the porous body with an ionomer, rolling the product, and forming ionomer layers on both surfaces. In preferred aspects, the porous body can exhibit uniform pores, with a pore uniformity between 0.8 and 1.2, and comprises or consists of laminated fiber nets arranged at predetermined angles with an adhesive layer on the fiber surfaces.

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures have been shown to be enlarged than actual for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” another part, this includes not only the case where it is “directly on” the other part, but also the case where there is another part therebetween. Conversely, when a part of a layer, film, region, plate, etc. is said to be “under” another part, this includes not only the case where it is “directly under” the other part, but also the case where there is another part therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among those in which these numbers are essentially different, they should be understood as being modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated.

The process for manufacturing an e-PTFE electrolyte membrane for a membrane-electrode assembly of a fuel cell can be exemplarily carried out as follows. A molded body pre-molded by mixing PTFE raw materials may be prepared, the molded body may be injected into a plane shape, pins may be fixed and stretched on one side and the other side of a plane-shaped injection product to form e-PTFE, this stretched material may be impregnated with an ionomer, and an additional ionomer layer may be formed on one surface and the other surface of the impregnated material to manufacture an electrolyte membrane.

In the case of the electrolyte membrane manufactured in this manner, as described in the Background Art, the hydrogen ion conductivity may deteriorate due to the non-uniformity of the pores of e-PTFE, and the physical robustness may be unstable, and the deviation of the volume expansion rate may be large due to the non-uniformity of the density.

The present inventors have invented a porous body having a structure that solves such problems and a method for manufacturing an electrolyte membrane, which will be described in detail below.

Method for Manufacturing a Porous Body with Uniform Pores

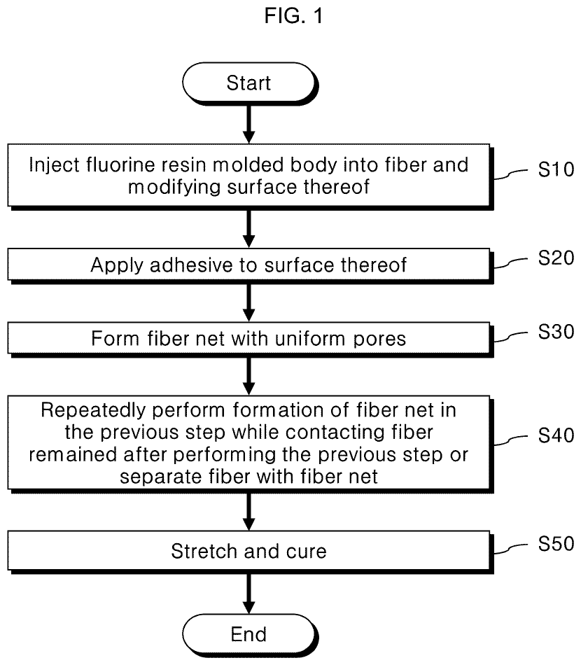

Referring to FIGS. 1, 3, and 4, a method for manufacturing a porous body with uniform pores according to one embodiment of the present disclosure may include:
(a) a step (S10) of injecting a fluorine-based polymer molded body into the form of a fiber and modifying the surface thereof;
(b) a step (S20) of applying an adhesive to the surface of the fiber on which the step (a) (S10) has been performed;
(c) a step (S30) of forming a fiber net with uniform pores through the fiber on which the step (b) (S20) has been performed;
(d) a step (S40) of repeatedly performing the formation of the fiber net in the step (c) (S30) while contacting the fiber remaining after performing the step (c) (S30) or a separate fiber on which the steps (a) and (b) (S10, S20) have been performed with the fiber net, thereby manufacturing a preliminary porous body in which a plurality of fiber nets is laminated; and
(e) a step (S50) of stretching and curing-treating the preliminary porous body.

The fluorine-based polymer molded body of the step (a) (S10) may be prepared by mixing and pressing a polymer powder and a lubricant.

The fluorine-based polymer may include, for example, polytetrafluoroethylene (PTFE), an ethylene-tetrafluoroethylene copolymer (ETFE), polyvinylidene fluoride (PVDF), fluorinated ethylene-propylene (FEP), perfluoroalkoxy (PFA), etc., and may include or consist of polytetrafluoroethylene.

Conventional lubricants used in molding a fluorine-based polymer and easily removed by heat may be applied as the lubricant, and the lubricant may include hydrocarbon oils such as liquid paraffin, naphtha, toluene, xylene, etc., other alcohol-based substances, ketone-based substances, ester-based substances, etc.

The above pressing may be performed at a temperature of 15° C. to 50° C. and a pressure of 1 MPa to 10 MPa.

The injection of the step (a) (S10) may be performed so that the thickness of the fiber that is an injection product is 1 μm to 10 μm. The injection product may be allowed to have a fiber shape with such a thickness, so that it may be contributed that the porous body, which is a target manufactured product, secures uniform pores and physical properties.

The fiber injected in the step (a) (S10) may be a long fiber, may have a length capable of forming at least one fiber net, and may have a length capable of forming a plurality of fiber nets.

The injection pressure of the step (a) (S10) may be 10 MPa to 150 MPa.

The modification of the step (a) (S10) may be performed through a modifying agent including an alkali metal complex solution, and the modifying agent may include an alkali metal-naphthalene complex, and for example, sodium naphthalenide (trade name: Tetra-etch) solution may be applied as the modifying agent.

The adhesive of the step (b) (S20) may include one selected from the group consisting of an epoxy-based resin, an acrylic resin, a urethane-based resin, and combinations thereof.

In the step (b) (S20), the adhesive may be applied so that the weight ratio of the fiber and the adhesive is 1:0.1 to 1:1, and a method such as spray coating, dip coating, or the like may be performed. The adhesive may have a thickness of 0.1 μm to 2 μm and may have a thickness of 0.2 μm to 1.5 μm.

The formation of the fiber net of the step (c) (S30) may include a process of forming a first fiber structure including a plurality of straight lines and a second fiber structure that is in contact with the first fiber structure, has a predetermined angle therebetween, and includes a plurality of straight lines. The first fiber structure and the second fiber structure may include parallel straight lines and may include straight lines that are not parallel but can form substantially uniform pores together with adjacent fiber structures.

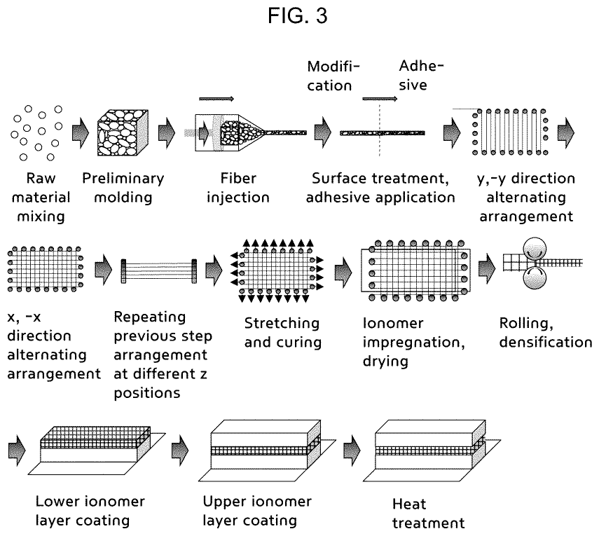

The first fiber structure of the step (c) (S30) may include a plurality of first straight lines that are parallel to each other as shown in the alternating arrangement of FIG. 3, and the respective first straight lines may have a predetermined interval in the x direction and may have equal intervals.

The second fiber structure of the step (c) (S30) may include a plurality of second straight lines that are parallel to each other as shown in the alternating arrangement of FIG. 3, and the respective second straight lines may have a predetermined interval in the y direction and may have equal intervals.

The first and second straight lines of the step (c) (S30) may have a predetermined angle therebetween, and the angle (acute angle) therebetween may be 30° to 90° and may be 60° to 90°.

The first and second straight lines may be substantially orthogonal and may have an angle therebetween of 90±3°. The above x-direction and y-direction may also be substantially orthogonal.

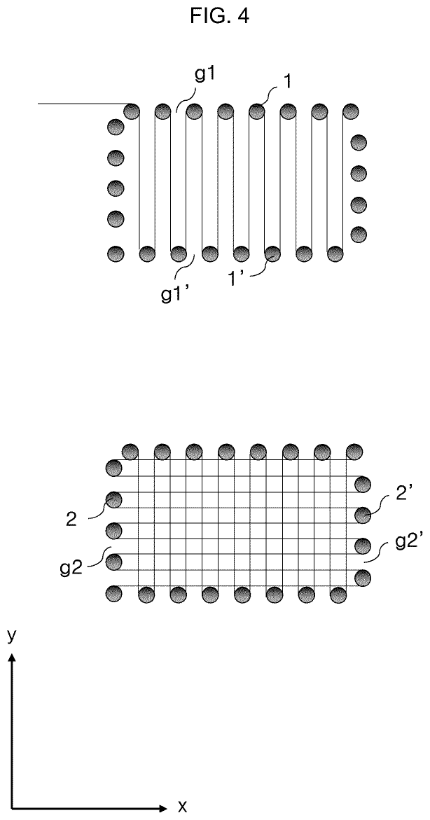

The first fiber structure of the step (c) (S30) may be formed through a first arrangement means. Referring to FIG. 4, the first arrangement means may specifically include:

a first pin part in which a plurality of first pins 1 are arranged with a predetermined interval g1 in the x-direction; and a first′ pin part in which a plurality of first′ pins 1′ are arranged with a predetermined interval g1′ in the x-direction, and the first′ pins 1′ of the first′ pin part may be arranged to face the intervals g1 of the first pin part in the opposite direction of the y-direction. In addition, the first pins 1 of the first pin part may be arranged to face the intervals g1′ of the first′ pin part in the y-direction. The above predetermined intervals g1 and g1′ may be equal intervals or may be irregular intervals capable of forming uniform pores of the porous body as illustrated in FIG. 7.

The second fiber structure of the step (c) (S30) may be formed through a second arrangement means. Referring to FIG. 4, the second arrangement means may specifically include:
a second pin part in which a plurality of second pins 2 are arranged with a predetermined interval g2 in the y direction; and a second′ pin part in which a plurality of second′ pins 2′ are arranged with a predetermined interval g2′ in the y direction, and the second′ pins 2′ of the second′ pin part may be arranged to face the intervals g2 of the second pin part in the x direction. In addition, the second pins 2 of the second pin part may be arranged to face the intervals g2′ of the second′ pin part in the opposite direction of the x direction. The above predetermined intervals g2 and g2′ may be equal intervals or may be irregular intervals capable of forming uniform pores of a porous body for the same purpose as the intervals g1 and g1′ as illustrated in FIG. 7.

The fiber that has undergone the step (b) (S20) may alternately contact in the order of the surface of the first pin 1, the surface of the first′ pin 1′ that is the most adjacent in the x direction, and the surface of the first pin 1 that is the most adjacent in the first arrangement means, thereby forming a first fiber structure.

The fiber remaining after forming the first fiber structure through the above first arrangement means may alternately contact in the order of the surface of the second pin 2, the surface of the second′ pin 2′ that is the most adjacent in the −y direction, and the surface of the second pin 2 that is the most adjacent in the −y direction in the second arrangement means, thereby forming a second fiber structure.

The above first pin 1, the first′ pin 1′, the second pin 2, and the second′ pin 2′ may have substantially the same shape, may have a shape that can minimize damage to the fiber, and may have a cylindrical shape. The above pins may be in a state that is temporarily fixed, may be in a state that is rotatable like rollers, and may be moved in an outward direction for stretching in a subsequent step.

The fiber that has a fiber net formed through the first and second arrangement means may have the formation of a fiber net repeatedly performed in the same manner at different z-direction heights (positions) of the pins in the subsequent step (d). The z direction may be a direction that is orthogonal to an upper direction from the xy-plane including the x direction and y direction.

In the step (d) (S40), the fiber net formation of the step (c) (S30) may be allowed to be repeated at a height (position) where the fiber remaining after the step (c) (S30) has been performed or a separate fiber on which the steps (a) and (b) have been performed is allowed to be in contact with the fiber net and the fiber net manufactured in the previous step, thereby manufacturing a preliminary porous body in which a plurality of fiber nets are laminated.

In the step (d) (S40), the number of repetitions may be 10 to 100 times, and preferably 10 to 50 times. With such a number of repetitions, the porous body may be formed to a target thickness.

The stretching of the step (e) (S50) may be performed in the order of the extension direction of the first straight line and the extension direction of the second straight line, or may be performed in the opposite order or regardless of the order. The extension direction of the straight line means the direction diverging along the straight line from the center of the straight line. The stretching may be performed such that the stretching ratio in the extension direction of the first straight line and the stretching ratio in the extension direction of the second straight line compared to before stretching are 1:1.2 to 1:20, respectively. Such stretching ratios are allowed to be satisfied so that the impregnation of the ionomer may be effectively performed during the manufacture of the electrolyte membrane, and the deterioration in the uniformity of the physical properties of the porous body may be minimized.

The curing of the step (e) (S50) may be carried out while applying hot air at a temperature of 50° C. to 100° C. Through this, the curing of the adhesive remaining in the preliminary porous body in which the step (d) (S40) has been performed may be performed, and the bonding force between the fiber nets in contact with each other may be secured and the internal structure of the porous body may be maintained.

After the step (e) (S50), a process of selectively separating or cutting the porous body from the first arrangement means and the second arrangement means may be optionally included.

Through the above method, a porous body 15 with uniform pores may be easily manufactured and may be applied as an impregnation membrane 20 of an electrolyte membrane 100.

### Method for Manufacturing an Electrolyte Membrane Including a Porous Body Having Uniform Pores

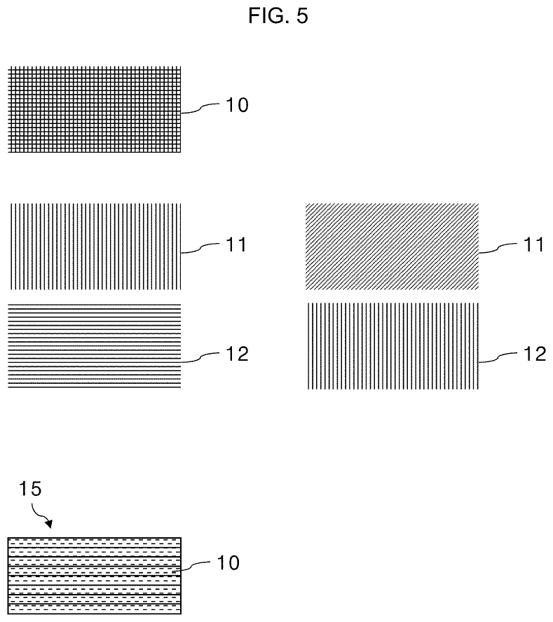

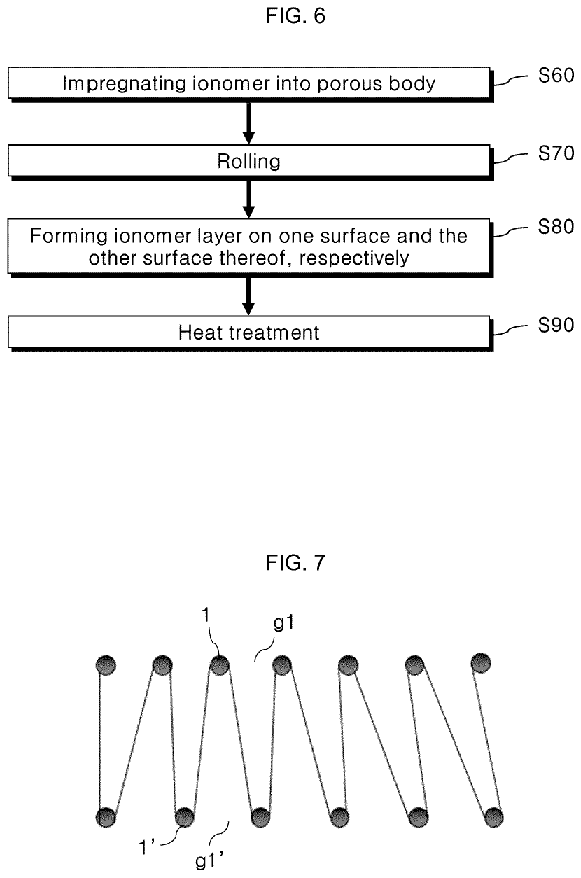

Referring to FIG. 5, a method for manufacturing an electrolyte membrane including a porous body having uniform pores according to one embodiment of the present disclosure may include
the steps (a) to (e) (S10 to S50),
(f) a step (S60) of impregnating an ionomer into the porous body manufactured by the step (e) (S50);
(g) a step (S70) of rolling the resultant product on which the step (f) (S60) has been performed; and
(h) a step (S80) of forming an ionomer layer on one surface and the other surface of the resultant product, respectively, on which the step (g) (S70) has been performed.

The ionomer may include, for example, a perfluorosulfonic acid-based ionomer, and may include tradenames Nafion, Flemion, Dow, Aciplex, Gore membrane, etc.

The rolling of the step (g) may be performed at a temperature of 30° C. to 150° C., and preferably at a temperature of 50° C. to 80° C. The temperature may correspond to the temperature of the roller, which is a rolling means, during rolling. The rolling may be applied in one stage or in multiple stages.

During the rolling of the step (g), the reduction ratio may be 10% to 95%, and may be 20% to 90%, based on the thickness of the final rolled product. The reduction ratio corresponds to a percentage of (reduction amount/thickness before rolling), and the reduction amount is the difference between the thickness before rolling and the thickness after rolling.

The method for manufacturing an electrolyte membrane including a porous body having uniform pores may include (i) a step (S90) of heat-treating the resultant product on which the step (h) (S80) has been performed. The heat treatment temperature of the step (i) may be 80° C. to 200° C., and preferably 120° C. to 180° C.

The electrolyte membrane 100 manufactured by the above-described method for manufacturing an electrolyte membrane including a porous body having uniform pores may maintain the uniform pores and physical properties of the internal porous body even after ionomer impregnation, rolling, and heat treatment, may have high hydrogen ion conductivity, and may have excellent physical robustness.

### Porous Body 15

Referring to FIG. 5, etc., the porous body 15 according to one embodiment of the present disclosure comprises,
a laminate of a plurality of fiber nets 10 including a fluorine-based polymer
the fiber nets 10 may comprise: a first fiber structure 11 including a part in which a plurality of fibers are arranged; a second fiber structure 12 including a part which is in contact with the first fiber structure 11, having a predetermined angle therebetween and including a portion in which a plurality of fibers are arranged; and an adhesive layer which is included in a portion or all of the surface of the first fiber structure 11 and a portion or all of the surface of the second fiber structure 12, and
may have a pore uniformity according to Equation 1 below of 0.8 to 1.2.

$$Pore uniformity = average pore size measured from an object obtained by cutting a predetermined region of the porous body / average pore size measured from an object obtained by cutting another predetermined region of the porous body \qquad [ Equation 1 ]$$

In Equation 1 above, the predetermined region may be 100×100×100 μm³, or may have any one of 1/100 times to 1/10 times the size of the porous body, and the average pore size of the porous body and the cut product thereof may be measured through Capillary Flow Porometer equipment.

The plurality of fibers of each of the first fiber structure 11 and the second fiber structure 12 may refer to a fiber part corresponding to a straight part in a fiber structure composed of a single continuous long fiber.

The first fiber structure 11 and the second fiber structure 12 may include a part in which a plurality of fibers are arranged parallel to each other, and may include one in which the plurality of fibers are arranged parallel to each other.

The porous body 15 above may have a pore uniformity of 0.9 to 1.1, and may have an error range of ±5% from 1.

The pore shape of the porous body 15 above may be a polygonal shape, and may include shapes such as a triangle, a square, a parallelogram, and other figures.

The fluorine-based polymer and fiber diameter of the fiber net 10 above are the same as those described above, so redundant descriptions are omitted.

The adhesive layer of the fiber net 10 has the substantially same component and content as in the adhesive described above, so redundant descriptions are omitted.

The first fiber structure 11 and the second fiber structure 12 may have fibers that are orthogonal to each other or have an angle therebetween of 90±3°, as shown on the left side of FIG. 5.

The first fiber structure 11 and the second fiber structure 12 may have an angle (acute angle) between each fiber of 30° to 90°, or 60° to 90°, as shown on the right side of FIG. 5.

The porous body 15 may be formed by laminating one fiber net 10 and an adjacent other fiber net 10 at the same horizontal position when viewed in the thickness direction from above (plan view).

The porous body 15 may have almost no thickness deviation and may exhibit substantially uniform physical properties. The porous body 15 may have a thickness of 10% to 75% based on the thickness (100%) of the electrolyte membrane 100 described later. If the thickness is less than 10% compared to the electrolyte membrane, it may be difficult to secure the physical rigidity of the electrolyte membrane, and if the thickness is more than 75% compared to the electrolyte membrane, deterioration of the membrane performance may occur due to deterioration of ion conductivity.

### Electrolyte Membrane 100

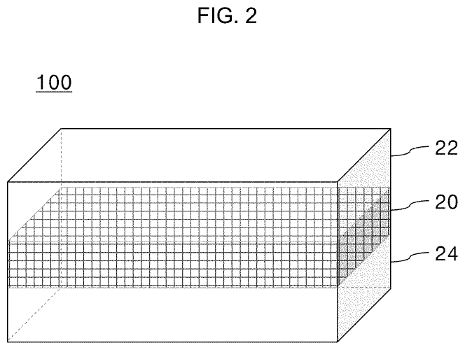

Referring to FIG. 2, the electrolyte membrane 100 according to one embodiment of the present disclosure may include an impregnation membrane 20; and ionomer layers (22, 24) provided on each of both surfaces thereof, and the impregnation membrane 20 is one obtained by heat-treating it after impregnating and rolling a porous body 15 and an ionomer, and the porous body 15 is the same as the porous body 15 described above.

In the electrolyte membrane 100, the ionomer of the impregnation membrane 20 and the ionomer of the ionomer layer may be the same, or they may have different physical properties.

The above electrolyte membrane 100 may be applied to a membrane-electrode assembly and a fuel cell, and electrode layers may be disposed on both surfaces thereof.

In the above electrolyte membrane 100, a porous body (15) having uniform pores and properties is applied to the impregnation membrane 20 so that the impregnation membrane 20 may maintain uniform pores and physical properties, have high hydrogen ion conductivity, and have excellent physical robustness.

Although the embodiments of the present disclosure have been described above, those skilled in the art to which the present disclosure pertains will understood that the present disclosure can be implemented in other specific forms without changing technical spirit or essential features thereof. Therefore, it should be understood that the embodiments described above are illustrative in all aspects and not restrictive.

### EXPLANATION OF REFERENCE NUMERALS

| 1: First pin | 1′: First′ pin |
|---|---|
| 2: Second pin | 2′: Second′ pin |
| 10: Fiber net | |
| 11: First fiber structure | 12: Second fiber structure |
| 15: Porous body | |
| g1: Interval of first pin part | g1′: Interval of first′ pin part |
| g2: Interval of second pin part | g2': Interval of second′ pin part |

20: Impregnation membrane
22, 24: Ionomer layer
100: Electrolyte membrane

What is claimed is:

1. A method for manufacturing a porous body with uniform pores, the method comprising steps of:
(a) injecting a fluorine-based polymer molded body into the form of a fiber and modifying a surface thereof;
(b) applying an adhesive to the surface of the fiber;
(c) forming a fiber net with uniform pores through the fiber;
(d) repeatedly performing the formation of the fiber net while contacting the fiber remaining after performing the step (c) or a separate fiber on which the steps (a) and (b) have been performed with the fiber net, thereby manufacturing a preliminary porous body in which a plurality of fiber nets are laminated; and
(e) stretching and curing the preliminary porous body.

2. The method of claim 1, wherein the fluorine-based polymer molded body is prepared by mixing and pressing a polymer powder and a lubricant.

3. The method of claim 1, wherein the injection of the step (a) is performed so that the thickness of the fiber is about 1 μm to 10 μm.

4. The method of claim 1, wherein the modification of the step (a) is performed through a modifying agent including an alkali metal complex solution.

5. The method of claim 1, wherein the adhesive of the step (b) comprises one selected from the group consisting of an epoxy-based resin, an acrylic resin, a urethane-based resin, and combinations thereof.

6. The method of claim 1, wherein in the step (b), the adhesive is applied so that the weight ratio of the fiber and the adhesive is about 1:0.1 to 1:1

7. The method of claim 1, wherein the formation of the fiber net of the step (c) comprises a process of forming a first fiber structure including a plurality of straight lines and a second fiber structure that is in contact with the first fiber structure, has a predetermined angle therebetween, and comprises a plurality of straight lines.

8. The method of claim 7, wherein the first fiber structure has straight lines of the fibers repeatedly arranged at a predetermined interval in the x direction,
wherein the second fiber structure has straight lines of the fibers repeatedly arranged at a predetermined interval in the y direction, and
wherein the x direction and the y direction are orthogonal to each other.

9. The method of claim 8, wherein the first fiber structure of the step (c) is formed through a first arrangement means, and the first arrangement means comprises:
a first pin part in which a plurality of first pins are arranged with a predetermined interval in the x-direction; and
a first′ pin part in which a plurality of first′ pins are arranged with a predetermined interval in the x-direction, and
wherein the first′ pins of the first′ pin part are arranged to face the intervals of the first pin part in the opposite direction of the y-direction.

10. The method of claim 9, wherein the second fiber structure of the step (c) is formed through a second arrangement means, the second arrangement means comprises:
a second pin part in which a plurality of second pins are arranged with a predetermined interval in the y direction; and
a second′ pin part in which a plurality of second′ pins are arranged with a predetermined interval in the y direction, and
wherein the second′ pins of the second′ pin part are arranged to face the intervals of the second pin part in a direction opposite to the x direction.

11. The method of claim 1, wherein in the step (d), the number of repetitions is about 10 to 100 times.

12. The method of claim 10, wherein the stretching of the step (e) is performed by moving the first arrangement means and the second arrangement means.

13. The method of claim 1, wherein the stretching of the step (e) is performed at a stretching ratio of 1:1.2 to 1:20.

14. The method of claim 1, wherein the curing of the step (e) is carried out while applying hot air at a temperature of about 50° C. to 100° C.

15. The method of claim 1, wherein the adhesive is applied to form a layer with a thickness of 0.1 μm to 2 μm, and the adhesive is applied by spray coating or dip coating.

16. A method for manufacturing an electrolyte membrane including a porous body with uniform pores, the method comprising:
(a) injecting a fluorine-based polymer molded body into the form of a fiber and modifying a surface thereof;
(b) applying an adhesive to the surface of the fiber;
(c) forming a fiber net with uniform pores through the fiber;
(d) repeatedly performing the formation of the fiber net while contacting the fiber remaining after performing the step (c) or a separate fiber on which the steps (a) and (b) have been performed with the fiber net, thereby manufacturing a preliminary porous body in which a plurality of fiber nets are laminated;
(e) stretching and curing the preliminary porous body to form a porous body;
(f) impregnating an ionomer into the porous body manufactured in the step (e);
(g) rolling the resultant product on which the step (f) has been performed; and
(h) forming an ionomer layer on one surface and the other surface of the resultant product, respectively, on which the step (g) has been performed.

17. The method of claim 16, wherein the rolling of the step (g) is performed at a temperature of about 30° C. to 150° C.

18. The method of claim 16, further comprising a step of (i) heat-treating the resultant product on which the step (h) has been performed, wherein the heat treatment temperature of the step (i) is about 80° C. to 200° C.

19. A porous body comprising:
a laminate of a plurality of fiber nets including a fluorine-based polymer,
wherein the fiber nets comprises:
a first fiber structure including a portion in which a plurality of fibers are arranged;
a second fiber structure in contact with the first fiber structure, having a predetermined angle therebetween and including a portion in which a plurality of fibers are arranged; and
an adhesive layer which is included in a portion or all of the surface of the first fiber structure and a portion or all of the surface of the second fiber structure,
wherein the porous body has a pore uniformity according to Equation 1 below of about 0.8 to 1.2.
$$Pore uniformity = average pore size measured from an object obtained by cutting a predetermined region of the porous body / average pore size measured from an object obtained by cutting another predetermined region of the porous body \qquad [ Equation 1 ]$$

20. The porous body of claim 19, wherein the porous body is formed by laminating one fiber net and an adjacent other fiber net at the same horizontal position when viewed in the thickness direction.
